(19) United States
(12) Patent Application Publication
(10) Pub. No.: US 2004/0205621 A1
(43) Pub. Date: Oct. 14, 2004

(54) Method and apparatus for formatting documents

(76) Inventors: Steven C. Johnson, Eagle, ID (US); Shane R. Konsella, Star, ID (US)

Correspondence Address: HEWLETT-PACKARD COMPANY, Intellectual Property Administration, P.O. Box 272400, Fort Collins, CO, 80527-2400, US

(21) Appl. No.: 10/157,603

(22) Filed: May 28, 2002

(51) Int. Cl. G06F 17/24

(52) U.S. Cl. 715/523

(57) ABSTRACT

A document formatting system receives an electronic document and processing instructions from a device. The processing instructions contain information regarding how to process the electronic document. The electronic document is reformatted based on the information contained in the processing instructions. The reformatted document is then provided to a destination device, such as a printer or display device, which renders or otherwise processes the reformatted document.

### TECHNICAL FIELD

The present invention relates to document handling devices and, more particularly, to document formatting systems.

### BACKGROUND

In today's electronically interconnected world, it is common to encounter electronic documents in a variety of different formats. Electronic documents may be received in electronic mail (e-mail) messages, retrieved from the Internet, or stored on a variety of different computing systems, such as servers, workstations, portable computing devices and cellular phones. Electronic documents may contain text, graphics, or a combination of both text and graphics. Some electronic documents may be monochrome while other documents include color graphics or color text in all or a portion of the electronic document. Different types of computing systems support different types of documents and are capable of displaying varying types of information.

Electronic documents may be retrieved or identified for display, printing, or other processing on a particular type of device (e.g., a desktop computer, a portable computer, a personal digital assistant (PDA), or a cellular phone). If a user of a device attempts to display an electronic document on a device that does not support the format of the electronic document, an error will result. Similarly, if the device attempts to read, print, or otherwise process an incompatible electronic document, errors will occur. For example, the device may be attempting to display or print an electronic document that contains graphics elements that are not supported by the device. Alternatively, the electronic document may be formatted for a word processing application which is not contained on the device, thereby preventing the device from reading the electronic document.

Since there are numerous types of devices and many different formats in which electronic documents can be created and stored, it is not practical to allow every device to process every type of electronic document. Although a particular device may support more than one document format by installing multiple applications, it is not practical to install an application for every electronic document format. Similarly, it is not practical to translate every electronic document into every format necessary to support all devices that may attempt to read the electronic document. Attempting to support all types of electronic documents on all types of devices would require an ongoing process of developing new electronic documents each time a new device or a new document format is created. Such a task is not practical considering the time and expense involved to repeatedly modify documents each time a new document format or a new device is introduced.

### SUMMARY

The present invention translates an electronic document from one format to another such that the electronic document can be processed by the target device, which is not capable of processing the electronic document in its original format. The same electronic document may be translated into multiple different formats for processing on multiple different types of devices. A particular device can be configured to automatically translate electronic documents into a format that can be processed by the device.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 illustrates an embodiment of a network environment in which multiple devices are coupled to a document formatting system via a data communication network.

FIG. 2 is a block diagram showing pertinent components of a document formatting system in accordance with an embodiment of the invention.

FIG. 3 is an embodiment of a flow diagram illustrating a procedure for reformatting electronic documents.

FIG. 4 illustrates an embodiment of a network environment in which multiple devices communicate with a document formatting system through a data communication network.

FIG. 5 is an embodiment of a flow diagram illustrating a procedure for reformatting an electronic document and returning the document to a source device.

### DETAILED DESCRIPTION

An embodiment of the present invention provides for the translation of an electronic document from one format to another such that a particular device can process the electronic document. By allowing the translation of a single electronic document into multiple different formats, it is not necessary to create multiple different electronic documents or maintain many different applications on a particular device. Instead, a single electronic document is translated into different formats as necessary. When requesting an electronic document from a source, a device may identify the document formats supported by the device such that the source of the electronic document or a document formatting system can translate the document into an appropriate format for the device. As used herein, the terms “reformatting” and “translating” a document are equivalent.

An embodiment of the present invention eliminates the need for users in a shared network environment to standardize on a particular set of software, portable document format, or printer in order to share documents. Using the methods and systems described herein, documents are automatically translated into the appropriate format required for displaying, printing, or otherwise processing the documents. Additionally, an embodiment of the present invention eliminates the need for device drivers (such as printer drivers) to be installed on each computer. Instead, multiple device drivers can be maintained on one or more servers (also referred to as “document formatting systems”) that use the device drivers to translate documents, as needed.

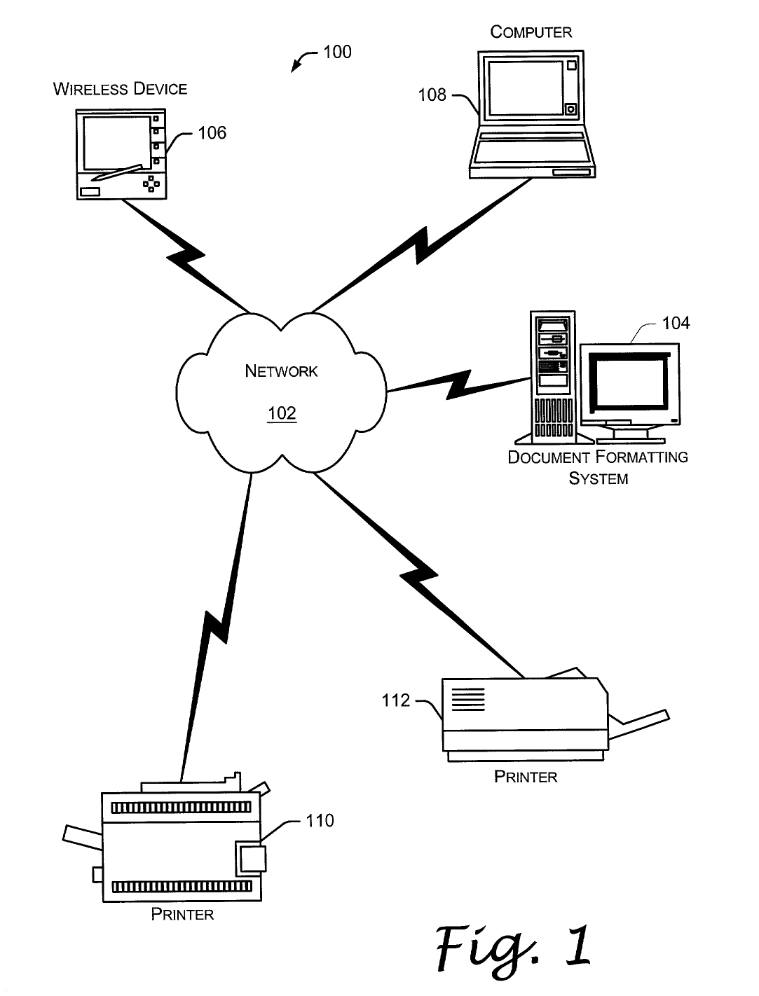

FIG. 1 illustrates a network environment 100 in which multiple devices are coupled to a document formatting system via a data communication network 102. The network 102 couples together a document formatting system 104, a wireless device 106, a laptop computer 108, and two printers 110 and 112. Network 102 can be any type of network, such as a local area network (LAN) or a wide area network (WAN), using any type of network topology and any network communication protocol. In a particular embodiment, network 102 is the Internet. Although only a few devices are shown coupled to network 102, a typical network may include tens or hundreds of devices coupled to one another. Furthermore, network 102 may be coupled to one or more other networks (not shown), thereby providing coupling between a greater number of devices. As used herein, the term “document” (or “electronic document”) includes, without limitation, text files, word processor files, spreadsheets, drawings, audio data, tables, a set of database entries, web pages, and any other collection of data, information, or graphical images. Additionally, a document may contain multiple objects, such as a word processing document that includes one or more embedded drawings and/or tables. A document may also be an audio recording, such as a voicemail message. Alternatively, a document may be a voicemail message that has been converted into a text document.

Document formatting system 104 can be implemented, for example, using a computer system such as a server, desktop computer system, or other computing mechanism capable of performing the various tasks and procedures described herein. Wireless device 106 can be any type of cellular phone, handheld computer, personal digital assistant (PDA), or other device capable of establishing a wireless communication link with network 102. Computer 108 may be any type of computing system, such as a laptop computer, a desktop computer or a server. Particular embodiments of the invention illustrate printers 110 and 112 as laser printers. However, alternate embodiments of the invention are implemented with ink-jet, bubble-jet or any other type of printer. Furthermore, the teachings of the present invention may be applied to any type of printing device or display device, such as copiers, fax machines, video display devices, and video projectors. As further discussed below, the document formatting system 104 is capable of converting electronic documents from a variety of source formats to a variety of target formats.

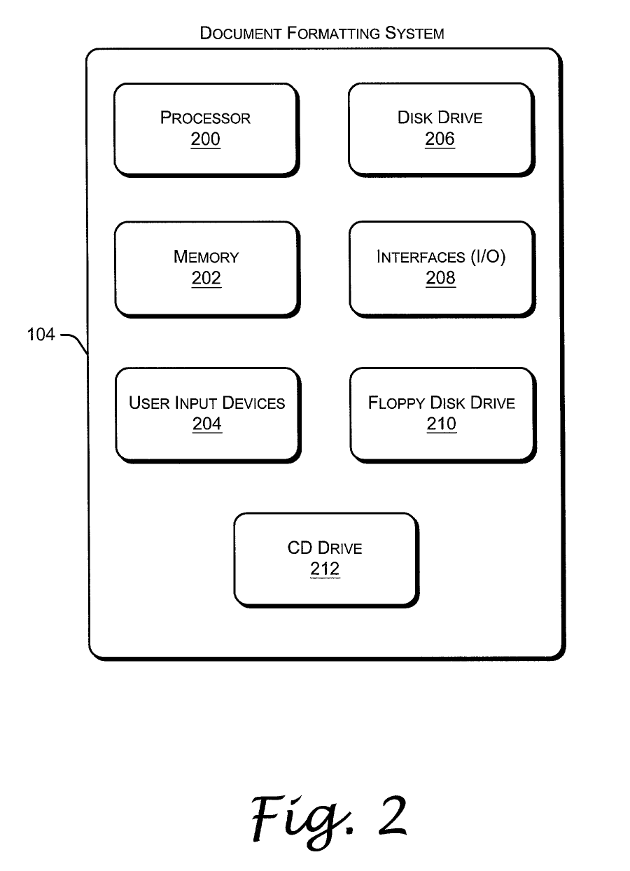

FIG. 2 is an embodiment of a block diagram showing pertinent components of document formatting system 104 in accordance with the invention. Document formatting system 104 includes a processor 200, a memory 202 (such as read-only memory (ROM) and random access memory (RAM)), user input devices 204, a disk drive 206, interfaces 208 for inputting and outputting data, a floppy disk drive 210, and a CD drive 212. Although not shown in FIG. 1, document formatting system 104 may also include a digital versatile disc (DVD) drive or other data storage mechanism. Processor 200 performs various instructions to control the operation of document formatting system 104. Memory 202, disk drive 206, floppy disk drive 210, and CD drive 212 provide data storage mechanisms. User input devices 204 include a keyboard, mouse, pointing device, or other mechanism for inputting information to document formatting system 104. Interfaces 208 provide a mechanism for document formatting system 104 to communicate with other devices (e.g., via network 102).

A particular device can be configured (manually or automatically) with information about the device's capabilities, such as the applications and drivers installed on the device. These applications and drivers may include, for example, Microsoft® Word available from Microsoft Corporation of Redmond, Wash., Adobe Acrobat® Reader available from Adobe Systems Incorporated of San Jose, Calif., or a particular printer driver. The device configuration may also include the user's preferences for document reformatting or document printing, such as converting drawing files into bitmap files or identifying a particular printer for printing documents. A table such as Table 1 below may be used to identify and maintain device configuration information.

TABLE 1

| Original | | |
|---|---|---|
| Document Format | Translation Preference | Physical Destination |
| Word Processing | PDF for Acrobat Reader | Network_name/device |
| Application | | |
| Scheduler | PCL5 | LPT1: |
| Application | | |
| Drawing | Bitmap | Network_name/application |
| Application | | |

The information contained in Table 1 can be stored in the device, in the document formatting system or any other location that is accessible by the document formatting system. The “Original Document Format” column identifies the format of document being processed (e.g., the type of application that created the document). The “Translation Preference” column identifies the manner in which the user wants each type of document to be translated (e.g., into a PDF format, a PCL5 format, or a bitmap format). The “Physical Destination” column identifies the destination to which the translated document is sent or stored. The destination may be a printer port (e.g., LPT1:), a storage location, a particular device (e.g., network_name/device), or a particular application (e.g., network_name/application) that knows how to process or display the translated document. The particular device may be a disk drive, printer, or other device. In the reference “network_name/device”, network_name identifies the path to the device, which may include a reference to one or more networks. In the example of Table 1, if a particular device already had the word processing application installed, then no translation is needed and the entry in Table 1 can be removed.

When a device attempts to print, display, or otherwise process a document, the device determines whether the document can be processed by the device alone or whether the document needs to be reformatted (i.e., the document is in a format not supported by the device). The determination of whether the document can be processed by the device alone may be based on the filename extension of the document or other information known about the type of processing the document requires (e.g., from Table 1 or similar tables). If the document can be processed by the device alone, the device processes the document as requested. If the document needs to be reformatted and/or processed by a different device, the document is communicated to a document formatting system, as discussed below.

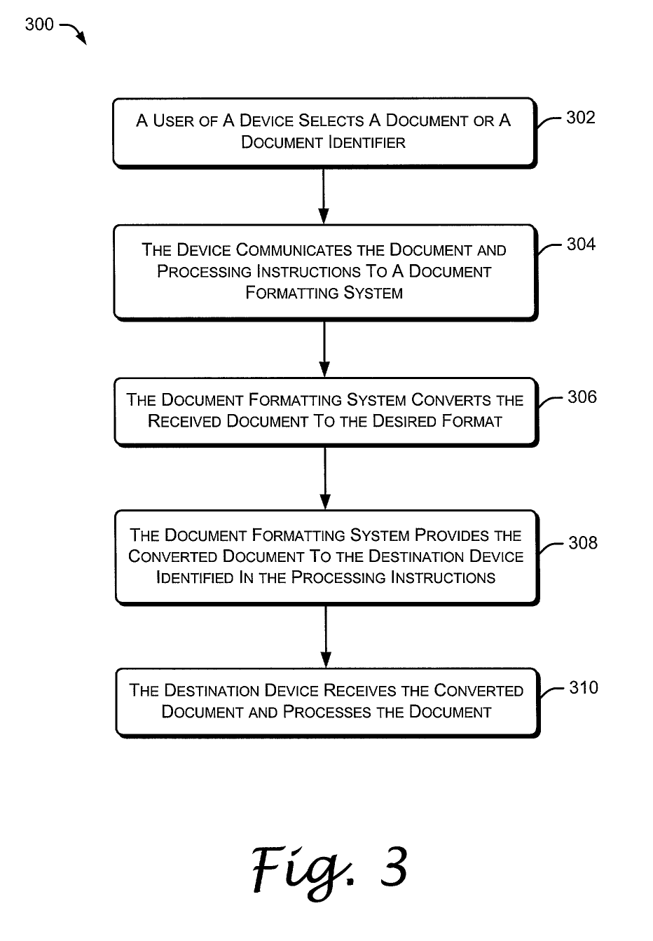

FIG. 3 is a flow diagram illustrating a procedure 300 for reformatting (or translating) electronic documents. Initially, a user of a device (e.g., wireless device 106 or computer 108 in FIG. 1) selects a document or a document identifier, such as an icon or the name of the document (block 302). The user may also indicate whether the selected document should be displayed on the device, displayed on a different device (e.g., a video projector coupled to the device through network 102), printed on a printer coupled to the device, or printed on a different device, such as printer 110 or 112 coupled to network 102. The device communicates the document and associated processing instructions to a document formatting system (block 304). Instead of communicating the document to the document formatting system, alternate embodiments communicate an identifier to the document formatting system that allows the document formatting system to retrieve the proper document.

The processing instructions mentioned above contain information about how the electronic document is to be processed by the document formatting system. For example, the processing instructions may identify the destination of the document (i.e., return the reformatted document to the device or transmit the reformatted document to another system, such as a printer, coupled to network 102) or may identify the type of format conversion necessary or the types of formats supported by the device (e.g., the source device or the destination device). The processing instructions may also contain information identifying the destination device type to the formatting system so that the formatting system can correlate the device type with device characteristics through a database stored on the formatting system. The correlated destination device characteristics would indicate how the electronic document is to be processed by the document formatting system. Specific processing instructions may contain information relating to the type of printer to be used to print the associated document, various printer settings (such as margins, font type, paper size, paper orientation, number of copies, etc.), and header and footer information associated with the document.

After receiving the electronic document, the document formatting system converts the received document to the desired format (block 306) based on information contained in the processing instructions or based on a destination device identified in the processing instructions whose characteristics are correlated through a system database. For example, a word processing document may be converted into a PDF file used by Adobe Acrobat Reader or a document to be printed may be converted into PCL5 (printer control language 5) for printing on a particular printer. PCL5 is a page description language developed by Hewlett-Packard Company of Palo Alto, Calif. Next, the document formatting system provides the converted document to the destination device identified in the processing instructions (block 308). The destination device may be, for example, the source of the original document or a printer coupled to network 102. Finally, the destination device receives the converted document and processes the document (block 310). This processing may include displaying the converted document on a display screen, projecting the converted document using a video projector, or printing the converted document on a printer.

An example of procedure 300 in FIG. 3 is provided with reference to the network environment 100 shown in FIG. 1. In this example, the user of wireless device 106 has located a web page that the user wants to print. The user selects the appropriate action (e.g., print) by touching the screen or a button on wireless device 106. The wireless device 106 transmits the uniform resource locator (URL) associated with the desired web page and processing instructions to document formatting system 104 via network 102. Document formatting system 104 retrieves the web page using the URL and converts the web page data into a format that is understood by the printer selected by the user. The processing instructions may identify one or more formats that are understood by the printer selected by the user. The formatted web page data is then transmitted to the printer across network 102 and printed by the printer. In this example, the wireless device 106 does not have to access or handle the actual document (i.e., the web page). Instead, the wireless device 106 sends the URL associated with the web page and the document formatting system 104 retrieves the web page using the URL.

In an alternate embodiment of the procedure shown in FIG. 3, at block 306 the document formatting system converts the received document into multiple different formats (e.g., formats that support multiple types of printers). The multiple different converted documents are then sent to multiple destination devices depending on the format understood by each destination device. In this embodiment, the processing instructions identify the multiple destination devices and the format (or formats) understood by each destination device such that the document formatting system can perform the appropriate conversions.

In another embodiment, multiple document formatting systems may be used to simultaneously convert the same document into multiple different formats. This embodiment is useful when different document formatting systems support different types of document conversions.

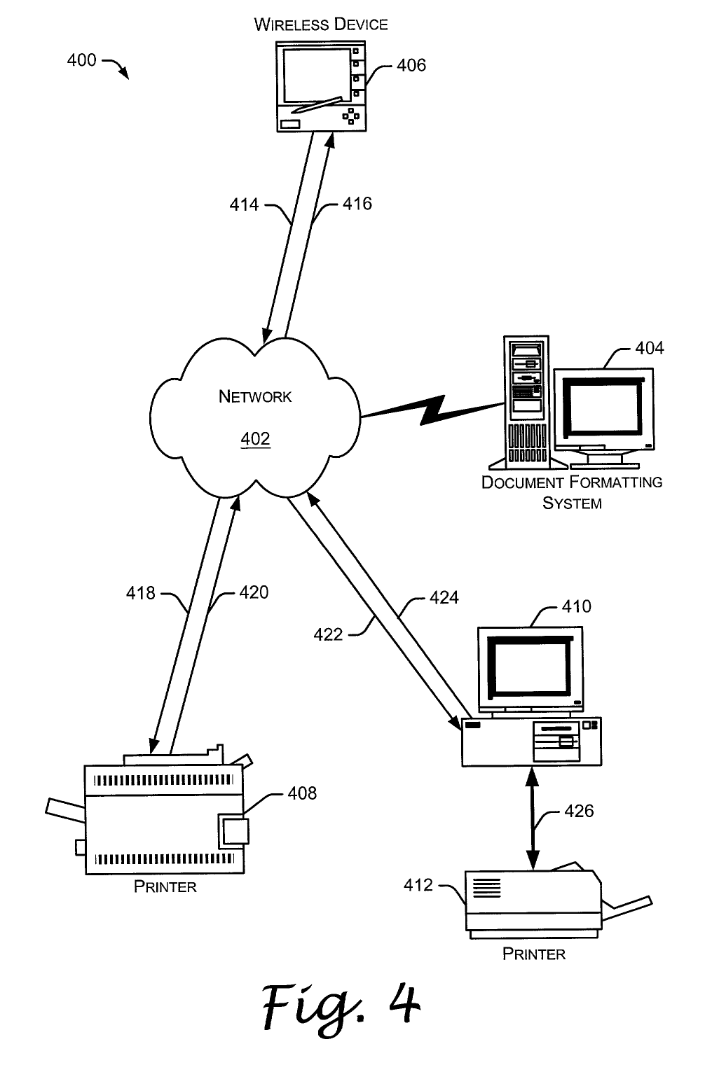

FIG. 4 illustrates a network environment 400 in which multiple devices communicate with a document formatting system 404 through a data communication network 402. Network 402 couples together the document formatting system 404, a wireless device 406, a computer 410, and a printer 408. Another printer 412 is coupled to computer 410 via communication link 426. Wireless device 406 is coupled to network 402 through communication links 414 and 416. Similarly, printer 408 is coupled to network 402 through communication links 418 and 420, and computer 410 is coupled to network 402 through communication links 422 and 424. Although communication links 414/416, 418/420, and 422/424 are shown as two separate unidirectional communication links, they are typically implemented as a single bidirectional communication link. For purposes of explanation, the various communication links are shown in FIG. 4 as two separate unidirectional communication links.

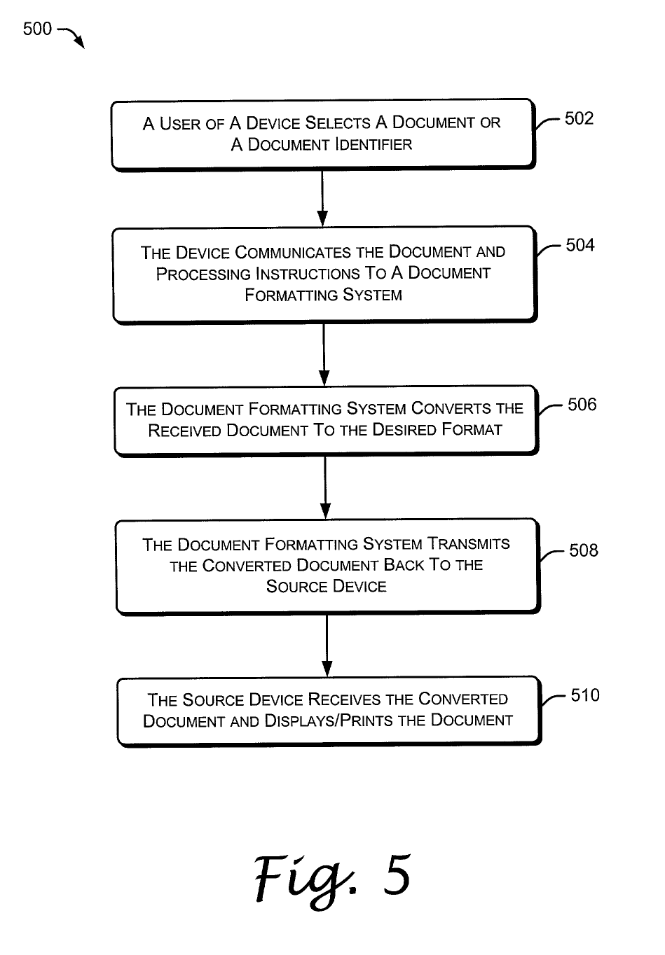

FIG. 5 is a flow diagram illustrating a procedure 500 for reformatting (or translating) an electronic document and returning the document to a source device. A user of a device selects a document or a document identifier (block 502). The device then communicates the document (or the document identifier) and associated processing instructions to a document formatting system (block 504). As discussed above, the processing instructions contain information regarding how the document is to be processed by the document processing system. The document formatting system converts the received document to the desired format (block 506) and transmits the converted document back to the source device (block 508). The source device receives the converted document and displays (or prints) the document (block 510).

An example of procedure 500 in FIG. 5 is provided with reference to the network environment 400 shown in FIG. 4. In this example, the user of wireless device 406 has located a web page that the user wants to display on the wireless device. The user selects the appropriate action (e.g., “display web page”) by touching the screen or a button on wireless device 406. The wireless device transmits the uniform resource locator (URL) associated with the desired web page and processing instructions to document formatting system 404 via communication link 414. Document formatting system 404 receives the request from wireless device 406 and retrieves the web page using the URL and converts the web page data into a format that can be displayed on the visual display on wireless device 406. The formatted web page data is then transmitted to the wireless device 406 via network 402 and communication link 416. Wireless device 406 then displays the web page data for viewing by the user of the device. Thus, wireless device 406 is able to view web pages without installing a web browser or similar application on the wireless device.

Alternatively, computer 410 may request to have a document reformatted by document formatting system 404 for printing the document on attached printer 412. In this example, the document and associated processing instructions are sent to document formatting system 404 using communication link 424. The reformatted document is returned on communication link 422. The reformatted document is then transmitted to printer 412 across communication link 426.

In another example, printer 408 sends a document or a document identifier to document formatting system 404 using communication link 420 and the link between network 402 and the document formatting system. After formatting the document, the document formatting system 404 transmits the printable version of the document back to printer 408 via communication link 418.

Thus, a document formatting system has been described herein that allows a device to send an electronic document to the document formatting system for processing. The document formatting system reformats the document for display or printing on a device (such as the originating device or another device coupled to the document formatting system via a network). This system reduces the number of different applications that need to be installed on a device. Instead, the centralized document formatting system converts documents having a variety of source formats into one of several different formats supported by printers and/or display devices.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A processor-readable medium comprising processor-executable instructions configured for:
receiving an electronic document from a device;
receiving processing instructions from the device, the processing instructions being associated with the electronic document and containing information regarding how to process the electronic document;
reformatting the electronic document pursuant to the information contained in the processing instructions; and
providing the reformatted electronic document to a destination device.

2. A processor-readable medium as recited in claim 1, wherein the destination device is a printer.

3. A processor-readable medium as recited in claim 1, wherein the destination device is the source of the electronic document.

4. A processor-readable medium as recited in claim 1, wherein the reformatted electronic document is displayed on the destination device.

5. A processor-readable medium as recited in claim 1, wherein the reformatting the electronic document includes reformatting the electronic document into a plurality of different formats.

6. A processor-readable medium as recited in claim 1, wherein the providing the reformatted electronic document to a destination device further includes determining whether the destination device is the source of the electronic document.

7. A processor-readable medium as recited in claim 1, comprising further processor-executable instructions configured for providing the reformatted electronic document to a plurality of destination devices.

8. A processor-readable medium comprising processor-executable instructions configured for:
receiving a reference from a device, wherein the reference identifies an electronic document;
receiving processing instructions from the device, the processing instructions being associated with the reference and containing information regarding how to process the electronic document;
retrieving the electronic document using the reference;
reformatting the electronic document pursuant to the information contained in the processing instructions; and
providing the reformatted electronic document to a destination device.

9. A processor-readable medium as recited in claim 8, wherein the destination device is a printer.

10. A processor-readable medium as recited in claim 8, wherein the reference is a uniform resource locator.

11. A processor-readable medium as recited in claim 8, wherein the reference includes a path to the electronic document.

12. A processor-readable medium as recited in claim 8, comprising further processor-executable instructions configured for providing the reformatted electronic document to a plurality of destination devices.

13. A processor-readable medium comprising processor-executable instructions configured for:
selecting an electronic document;
communicating the electronic document to a document formatting system;
creating processing instructions associated with the electronic document, wherein the processing instructions include information regarding processing the electronic document;
communicating processing instructions associated with the electronic document to the document formatting system; and
receiving a reformatted electronic document from the document formatting system.

14. A processor-readable medium as recited in claim 13, comprising further processor-executable instructions configured for printing the reformatted electronic document.

15. A processor-readable medium as recited in claim 13, comprising further processor-executable instructions configured for displaying the reformatted electronic document.

16. A processor-readable medium as recited in claim 13, wherein the source device is unable to display the electronic document prior to reformatting.

17. A processor-readable medium comprising processor-executable instructions configured for:
receiving an electronic document from a source device;
receiving processing instructions from the source device, the processing instructions including an identifier of a destination device;
correlating the identifier with characteristics of the destination device through a database;
reformatting the electronic document based on the characteristics of the destination device; and
providing the reformatted electronic document to a destination device.

18. A processor-readable medium as recited in claim 17, wherein the destination device is the source device.

19. A processor-readable medium as recited in claim 17, wherein the reformatted electronic document is printed on the destination device.

20. A processor-readable medium as recited in claim 17, wherein the reformatted electronic document is displayed on the destination device.

21. A processor-readable medium comprising processor-executable instructions configured for:
receiving a reference from a source device, wherein the reference identifies an electronic document;
receiving processing instructions from the source device, the processing instructions including an identifier of a destination device;
correlating the identifier with characteristics of the destination device through a database;
retrieving the electronic document using the reference;
reformatting the electronic document based on the characteristics of the destination device; and
providing the reformatted electronic document to the destination device.

22. A processor-readable medium as recited in claim 21, wherein the reference is a uniform resource locator.

23. A processor-readable medium as recited in claim 21, wherein the reference includes a path to the electronic document.

24. A processor-readable medium as recited in claim 21, comprising further processor-executable instructions configured for providing the reformatted electronic document to a plurality of destination devices.

25. A method of processing an electronic document, the method comprising:
receiving the electronic document from a device;
receiving processing instructions from the device, the processing instructions being associated with the electronic document and containing information regarding how to process the electronic document;
reformatting the electronic document pursuant to the information contained in the processing instructions; and
providing the reformatted electronic document to a destination device.

26. A method as recited in claim 25, wherein the destination device is a printer.

27. A method as recited in claim 25, wherein the destination device is the source of the electronic document.

28. A method as recited in claim 25, wherein the reformatted electronic document is displayed on the destination device.

29. A method as recited in claim 25, wherein reformatting the electronic document includes reformatting the electronic document into a plurality of different formats.

30. A method of processing an electronic document, the method comprising:
receiving a reference from a device, wherein the reference identifies the electronic document;
receiving processing instructions from the device, the processing instructions being associated with the reference and containing information regarding how to process the electronic document;
retrieving the electronic document using the reference;
reformatting the electronic document pursuant to the information contained in the processing instructions; and
providing the reformatted electronic document to a destination device.

31. A method comprising:
selecting an electronic document;
communicating the electronic document to a document formatting system;
creating processing instructions associated with the electronic document, wherein the processing instructions include information regarding processing the electronic document;
communicating processing instructions associated with the electronic document to the document formatting system; and
receiving a reformatted electronic document from the document formatting system.

32. A method comprising:
receiving an electronic document from a source device;
receiving processing instructions from the source device, the processing instructions including an identifier of a destination device;
correlating the identifier with characteristics of the destination device through a database;
reformatting the electronic document based on the characteristics of the destination device; and
providing the reformatted electronic document to a destination device.

33. A method comprising:
receiving a reference from a source device, wherein the reference identifies an electronic document;
receiving processing instructions from the source device, the processing instructions including an identifier of a destination device;
correlating the identifier with characteristics of the destination device through a database;
retrieving the electronic document using the reference;
reformatting the electronic document based on the characteristics of the destination device; and
providing the reformatted electronic document to the destination device.

34. A document formatting system comprising:
an interface configured to receive an electronic document from a device, the interface further configured to receive processing instructions from the device, wherein the processing instructions contain information regarding how to process the electronic document; and
a processor coupled to the interface and configured to reformat the electronic document based on the information contained in the processing instructions, the processor further configured to communicate the reformatted electronic document to a destination device.

35. A document formatting system as recited in claim 34 wherein the destination device is a printer.

36. A document formatting system as recited in claim 34 wherein the destination device is the device from which the electronic document was received.

37. A document formatting system as recited in claim 34 further comprising a storage device coupled to the processor, wherein the storage device stores a plurality of document conversion applications.
